(19) United States
(12) Patent Application Publication
(10) Pub. No.: US 2012/0310565 A1
(43) Pub. Date: Dec. 6, 2012

(54) APPARATUS AND METHOD FOR DETERMINING BATTERY/CELL'S PERFORMANCE, AGE, AND HEALTH

(76) Inventor: Laszlo Redey, Downers Grove, IL (US)

(21) Appl. No.: 13/481,539

(22) Filed: May 25, 2012

Related U.S. Application Data
(60) Provisional application No. 61/491,436, filed on May 31, 2011.

(51) Int. Cl. G01N 27/416; G06F 19/00

(52) U.S. Cl. 702/63

(57) ABSTRACT

A self-energized measuring system for determining primary and secondary battery/cell's performance, age, and health by measuring and recording battery/cell's voltage response to a specified load-changing perturbation spot-test event. The cell's voltage response is compared to a synchronously measured voltage signal of a comparator resistor. The relationship between the two voltage signals is analyzed on logarithmic time scale to determine performance parameters such as cell impedance and power and their variation in the time domain. The cell temperature is also measured for impedance and power normalization for 20 centigrade. Results are compared to a previously generated master data tabulation characteristic of a similar, new cell of perfect health condition. The time-domain performance parameters are related to the performance, age and health of the cell at any particular instant. The evaluation method can be easily adjusted to various battery chemistries, types.

The present application claims priority to provisional application Ser. No. 61/491,436, filed in the name of Laszlo Redey on May 31, 2011.

### BACKGROUND

1. Field of Invention

This invention relates to battery-cell-performance measuring apparatus and method. Particularly, to a self-energized measuring system used for determining primary and secondary battery/cell's performance, age, and health by measuring and recording battery/cell's voltage response to a specified load-changing perturbation spot-test event. The cell's voltage response is compared to a synchronously measured voltage signal of a comparator resistor. The relationship between the two voltage signals is analyzed on logarithmic time scale to determine time-domain performance parameters such as cell impedance and power and their variation in the time domain. The cell temperature is also measured and used for impedance and power normalization for the normal temperature of 20 centigrade. The spot-test results are compared to a previously generated master data tabulation that is characteristic of a similar, new cell of perfect health condition. The time-domain performance parameters are related to the performance, age and health of the cell at any particular instant. The evaluation method can be easily adjusted to various battery chemistries, types and application requirements.

2. Description of Prior Art

Battery testing is an important segment of battery development, manufacturing and application. Especially, the new demanding application scenarios would heavily rely on new testing methods that provide the needed sophisticated, even new-kind information such as performance capability, estimate the remaining mission capacity, age and health of the battery. Battery management, field testing, and monitoring are emphasizing the need for precise, reliable methods. The most powerful approach of monitoring of all these parameters focuses on impedance measurements methods. The previously used battery “resistance” term has been replaced and interpreted by battery impedance due to the very dynamic nature of battery applications. An example is the fast changing, fluctuating power demand in hybrid cars. In addition to robust stationary testing stations and facilities, “hand-held” instruments for field testing gain increasing importance.

Basically two main methods of impedance measurements for batteries are available and have been refined to higher precision and easier application. These are probing the battery by (a) an AC signal (AC frequency-domain analysis) and (b) a voltage change response generated by a temporary resistance load (DC analysis).

The AC probing method has been adapted from a laboratory method called electrochemical impedance spectroscopy. In battery applications, the probing AC signal includes a wide range of frequencies to be able to achieve sufficiently detailed information of battery states. The minute changes of the cell voltage as response to the AC perturbation are measured and analyzed. Disadvantages of this method include the need for sophisticated, complicated and usually expensive instrumentation and the lack of a straightforward, intuitive interpretation of the response signal. A prominent example of these devices is the Midtronics Multi-scope multiple-frequency battery analyzer disclosed in the instruction manual of the apparatus (P/N 168-4300D 5/03, 2003 copyright to Midtronics, Inc.)

On the other hand, the DC method applies a short resistor-load on the battery and measures the DC voltage response at the end of load application. The impedance is calculated from the end value of the voltage response and the measured current according to the Ohm's Law. The impedance information is limited owing to the discreteness of the time value.

An example of this method is disclosed in U.S. Pat. No. 5,744,962 to Alber et al. This prior solution is a data storing battery tester and multimeter for testing at least one battery in a plurality of batteries to predict whether said battery can provide a predetermined power level. This tester is adapted to determine at least the battery internal cell resistance, said battery being electrically connected in series by at least one conductive intercell link, said battery and batteries being connected to and used to supply power in electrical systems. Said tester includes an adjustable direct current (DC) resistance load, resistance loading means, being in electrical communication with said adjustable load, for selectively and automatically applying and removing said adjustable load across said battery while said battery remains connected to the electrical system to facilitate a load voltage and a float voltage, respectively, and to draw current. Said tester further includes processor means, in electrical communication with said resistance loading means, for reading said load voltage, said float voltage and said current draw and for calculating resistance of the intercell link and said internal cell resistance using said voltages and said current draw. Said load voltage, float voltage, current draw, intercell link resistance and internal cell resistance comprise data, said processor means including a prediction means for determining whether the battery can provide the predetermined power level based on said data. Said tester further includes memory means, in electrical communication with said processor means, for storing an algorithm used by said processor means to read and calculate said data and for storing said data, as well as computer interface means, in electrical communication with said processor means, for communicating and interfacing with at least one computer peripheral to facilitate transferring said data to said computer. Said tester further includes signal control means, in electrical communication with said resistance loading means and said processor means, for receiving input command signals and electrically providing output control signals to said processor means to facilitate the applying and removing of said adjustable load from said battery and processing of said data.

This apparatus is available under the name Cellcorder DC resistance test. Due to the highly automated nature, this solution uses a rigid measurement protocol. “Resistance” is calculated by difference of off-load and on-load cell voltage values divided by the measured current. The protocol, however, does not specify the load period and current, thereby ignores the fact that the resistance, impedance is a function of the load time and C-rate, wherein C-rate is equal to the current needed to fully discharge a battery.

An “inverse DC method” (termed interrupted galvanostatic cycling) has been developed by the Argonne National Laboratory, disclosed by T. D. Kaun, P. A. Nelson, L. Redey, D. R. Vissers and G. L. Henriksen, under the title “High-Temperature Lithium/Sulfide Batteries” (Electrochimica Acta, Vol 38. p. 1269, 1993.). Accordingly, during the regular constant-current charge-discharge cycling procedure the current is interrupted for a standard interval (usually 15 s). The interrupts are repeated at regular time steps. For electrodes of known area, an area-specific impedance (ASI) is calculated from the relaxed cell voltage and the current density applied before the interrupt. The ASI is a “virtual impedance” since it is measured on open circuit. The method and its application are described in a section of this latter reference. This method is especially useful for experimenting with easily fabricable, small physical-model cells. The obtained ASI values can be used in modeling and scale-up calculations.

Implementation of the described methods provides somewhat limited information of battery impedance because of either the cumbersome AC signal analysis or the discreteness of the impedance “time-stamped” value. The advanced, new-kind, and diversified battery application scenarios, however, would require more sophisticated methods. The improved methods should provide more complex impedance and performance parameter quantities in a broad time domain to help goal oriented applications. They should diagnose battery problems. Furthermore, the improved methods should help better battery selection at pre-installation studies, better maintenance, extend use and prevent too early battery disposal, thereby improve economy and ease environmental burden.

In spite of all these effort there is a need for a simple, but more effective method and apparatus to measure and document battery performance for practical use in the field of battery application technology.

The object of the invention is to meet this need.

A particular object of the invention is to provide a solution allowing a quick and concise evaluation of the condition of a battery by obtaining most relevant data characteristic to this condition by using a well defined protocol.

Further objects of the invention are the following:
providing a solution adapted to test batteries approximately at conditions near that of their normal use or even to test them while in use e.g. a car battery without disconnecting it from the car;
obtaining more reliable estimates relating to the performance, capability, estimate the remaining mission capacity, age and health of the battery;
providing more precise, reliable methods as well as an apparatus adapted for use in battery management, field testing, and monitoring.

Tests proved that battery impedance includes a stable component depending the mainly on type, structure and geometry of the battery, as well as a varying component depending on the actual conditions of the battery. This varying component derives from electrochemical phenomena and depends on a number of parameters including temperature, charged or discharged state, structural or microstructural changes of the battery caused by previous charging/discharging cycles, loading and charging conditions, particularly excessive loads or short circuits, e.t.c., respectively.

These varying components of a new, fully charged battery can be recorded in a master data table (MDT) and used as reference to evaluate the performance of the battery at a later stage after a period of use in order to draw conclusions relating to the performance of the battery if used under the same or similar conditions a previously.

This varying component is a non-linear function; however as a function of the logarithm of time it is nearly linear. Comparing this function with that of a new battery allows making more reliable estimations relating to capacity, age and health of the battery. This function can be normalized e.g. 20 centigrade, allowing tests to be made almost at arbitrary temperatures.

According to the invention a method is provided for generating data to evaluate quality of a (galvanic/fuel) cell to be tested, wherein parameters of a good quality reference cell of the same type are generated by performing the following operations:

a) measuring temperature of said cell versus time;

b) measuring voltage of said cell in load-free condition;

c) applying a predetermined load current across a comparator resistor to the cell for a first predetermined period

d) measuring voltage of said cell versus time during said first predetermined period;

e) measuring voltage drop on said comparator resistor versus time, wherein said current is evoked by said load current flowing from said cell during said first predetermined period;

f) switching off said load after the expiry of said first predetermined period;

g) measuring voltage of the cell versus time for a second predetermined period after switching off said load

h) normalizing data obtained by said steps a) to g) to a predetermined temperature

i) setting up a look-up table MDT comprising said normalized data identifying the type of the said cell and measured data;

j) generating parameters of the cell to be tested by performing the same operations as defined in steps a) to h);

k) conveying data gained as defined in j) for comparing them to the data of said look-up table MDT.

Further variants of the invented method are set forth in claims 2 to 7.

The invention also comprises an apparatus for carrying out the method, said apparatus includes means for

a) measuring temperature of a cell versus time

b) measuring voltage of said cell

c) applying a predetermined load current across a comparator resistor to the cell for a first predetermined period at a first time instant;

d) measuring voltage of said cell versus time during said first predetermined period;

e) measuring voltage drop on said comparator resistor caused by load current flowing from said cell d versus time during said first predetermined period;

f) switching off said load after the expiry of said first predetermined period;

g) measuring voltage of the cell versus time for a second predetermined period after switching off said load

h) conveying data gained as defined in h) for evaluation;

i) computing means adapted for normalizing said conveyed data to a predetermined temperature and for selecting values along a logarithmic time scale;

j) data storage for setting up a look-up table including data of a parameters of a good quality reference cell identifying the type of the said cell and measured data;

wherein said computing means is adapted to compare measured and normalized data of the cell to be tested with that of said reference cell previously stored in said look-up table

Further variants of the invented apparatus are set forth in claims 8 and 9.

### BRIEF DESCRIPTION OF THE DRAWINGS

FIG. 1 is a schematic illustration of a basic version of the invented apparatus used for generating TDPPS 75, shows cell under test connected.

FIG. 1A is a schematic illustration of a compensator voltage set 63.

FIG. 2 is a schematic illustration of embodiment 2 including a selector switch with a multiplicity of resistors used for generating TDPPS, TD_PDPPS, and MTD.

FIG. 3 is a schematic illustration of embodiment 3 including a charger used to generate STd-c type TDPPS.

FIG. 4A is a schematic illustration of embodiment 4 showing a case when the cell under test is part of its use-circuit in a service equipment. Comparator resistor and on-off switch are inserted in the circuit of the service equipment.

FIG. 4B is a schematic illustration of embodiment 4 showing a case when the cell under test is part of its use-circuit in a service equipment. A section of the circuit of the service equipment is used as comparator resistor.

FIG. 5 illustrates an example of a spot test including a stress and a relaxation section.

FIG. 6 illustrates stages of data processing from the measured-cell-voltage record to the calculated cell impedance in the time-domain. Only the stress section of a spot test is shown on FIG. 6. FIG. 6A shows a cell-voltage record on linear-section-time scale (71). FIG. 6B shows a cell-voltage record on logarithmic-section-time scale (73). FIG. 6C shows the corresponding cell impedance on logarithmic-section-time scale.

FIG. 7 shows the effect of temperature on cell's impedance and Vocv.

FIG. 8 shows a performance-capability diagram, PCD

FIG. 9 is a chart generated by Embodiment 2 in Example 1 indicating electrochemical changes along discharge in an alkaline-manganese-dioxide cell.

FIG. 10 shows the fast and slow components of cell reactions as function of SOD %. Impedance is used as indicator.

FIG. 11 shows a linear-time scale voltage plot of an STd-c four-section test.

FIG. 12 shows impedance of the four sections.

### TABLES

Table 1 shows an example of a TDPPS in table format.
Table 2 shows an example of a Master Data Tabulation, MDT. Table 3 shows a simplified form of MDT 101. In this form, the most important columns are shown only, those are the ones used in Example 7 evaluation.
Table 4 shows the temperature-function of the TDPPS values for the battery set evaluated in Example 7. This temperature-function table is used to normalize TDPPS for 20 centigrade.
Table 5 shows the summary of the battery-state estimates for batteries evaluated in Example 7.

### REFERENCE NUMERALS IN FIGURES

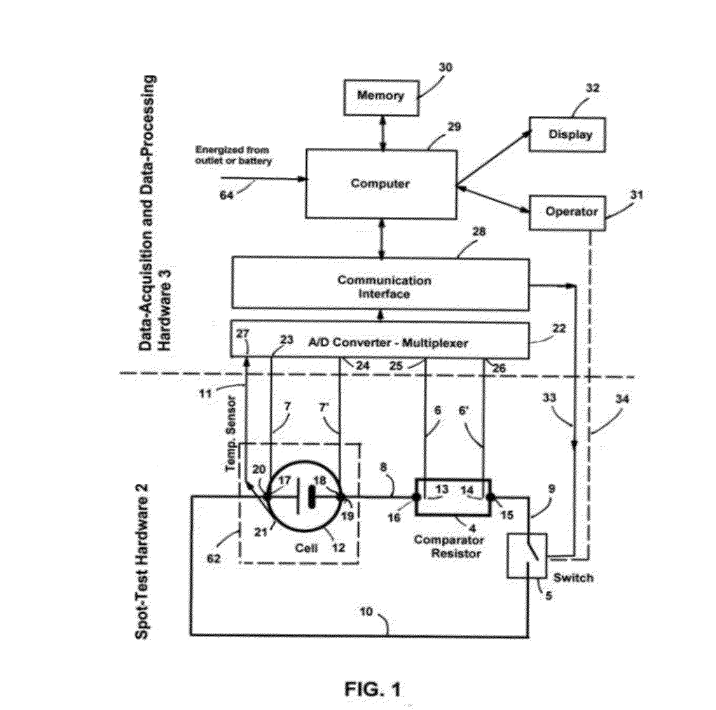

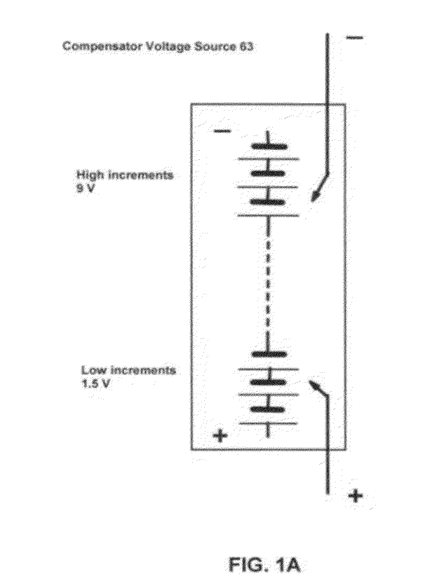

### Numerals in FIG. 1

1 Apparatus
2 Spot-test hardware, STH2
3 Data-acquisition and data-processing hardware, DPH 3
4 Comparator resistor
5 On-off switch
6 Voltage lead of comparator resistor 4.
6′ Voltage lead of comparator resistor 4.
7 Cell-voltage lead to cell 12
7′ Cell-voltage lead to cell 12
8 Current-carrying cable, a segment of circuitry.
9 Current-carrying cable, a segment of circuitry.
10 Current-carrying cable, a segment of circuitry.
11 Temperature sensor.
12 Cell under test.
13 Electrical-connection point for voltage lead 6 to comparator resistor 4
14 Electrical-connection point for voltage lead 6′ to comparator resistor 4
15 Electrical-connection point for cable 9 to comparator resistor 4
16 Electrical connection point for cable 8 to comparator resistor 4
17 Electrical connection point for voltage lead 7 to cell 12
18 Electrical connection point for voltage lead 7′ to cell 12
19 Electrical connection point for cable 8 to cell 12
20 Electrical connection point for cable 10 to cell 12
21 Electrically isolated thermal attachment point for temperature sensor 11 to cell 12
22 Analog-to-digital voltage-signal converter, channel multiplexer
23 Channel 1 high input. Voltage signal input to converter 22 from cell 12 through voltage lead 7
24 Channel 1 low input. Voltage signal input to converter 22 from cell 12 through voltage lead 7′
25 Channel 2 high input. Voltage signal input to converter 22 from comparator resistor 4 through voltage lead 6, Channel 2.
26 Channel 2 low input. Voltage signal input to converter 22 from comparator resistor 4 through voltage lead 6′
27 Channel 3. Electrical-connection for temperature sensor 11 to converter 22
28 Communication interface
29 Computer
30 Computer memory
31 Operator of test
32 Computer display
33 On-off operation control lead from interface 28 to switch 5
34 Manual on-off operation of switch 5 by operator 31
62 Holder of cell 12
63 Compensator voltage source (shown in FIG. 1A)
64 Energized from outlet or battery

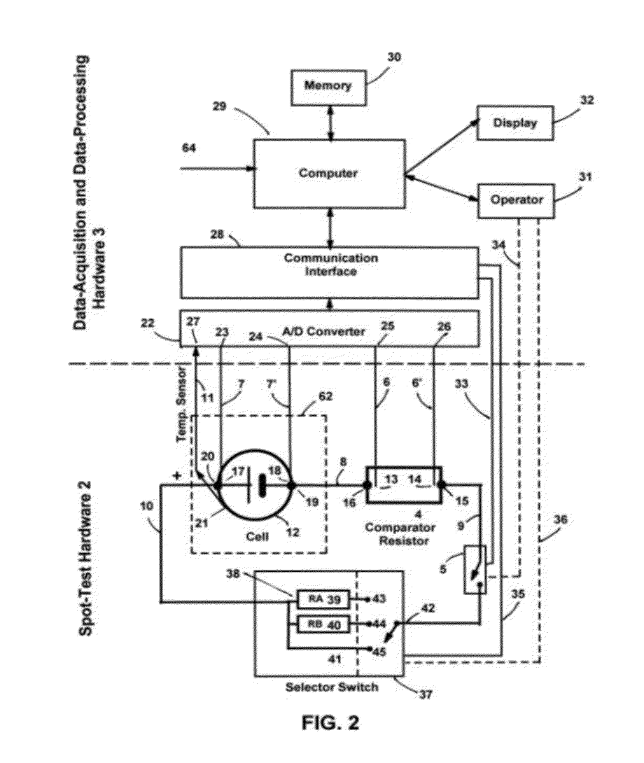

### Additional Numerals in FIG. 2

35 Control signal to contact selector 42 from communication interface 28.
36 Manual operation of contact selector 42 by operator 31.
37 Selector switch
38 Resistor set
39 Resistor A
40 Resistor B
41 Short circuit
42 Contact selector
43 Contact to Resistor A 39
44 Contact to Resistor B 40
45 Contact to short 41

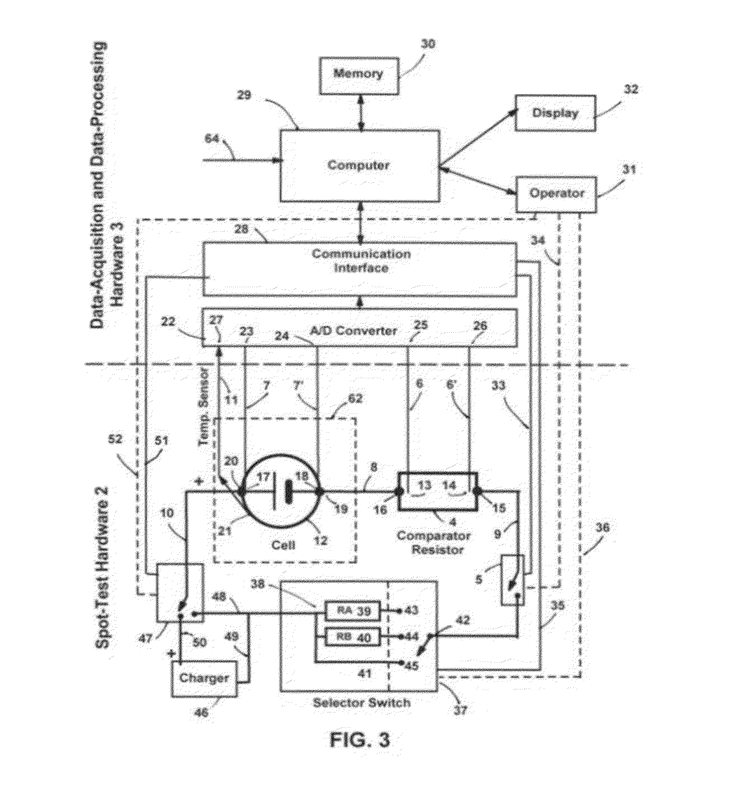

### Additional Numerals in FIG. 3

46 Charger
47 Charge-discharge selector switch
48 Current-carrying cable between selector switch 37 and switch 47
49 Current-carrying cable between selector switch 37 and charger 46
50 Current-carrying cable between charger 46 and switch 47
51 Charge-discharge control lead from interface 28 to switch 47
52 Manual operation from operator 31 to switch 47

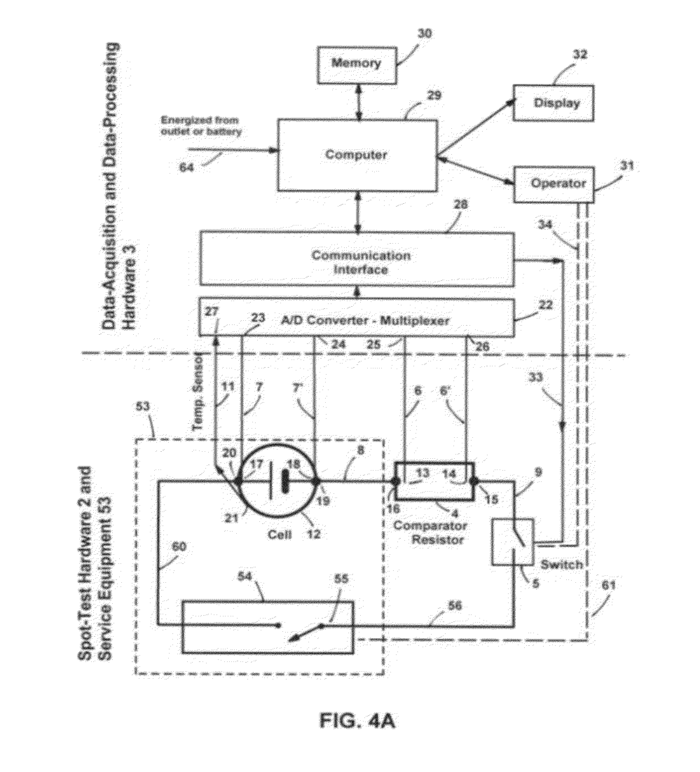

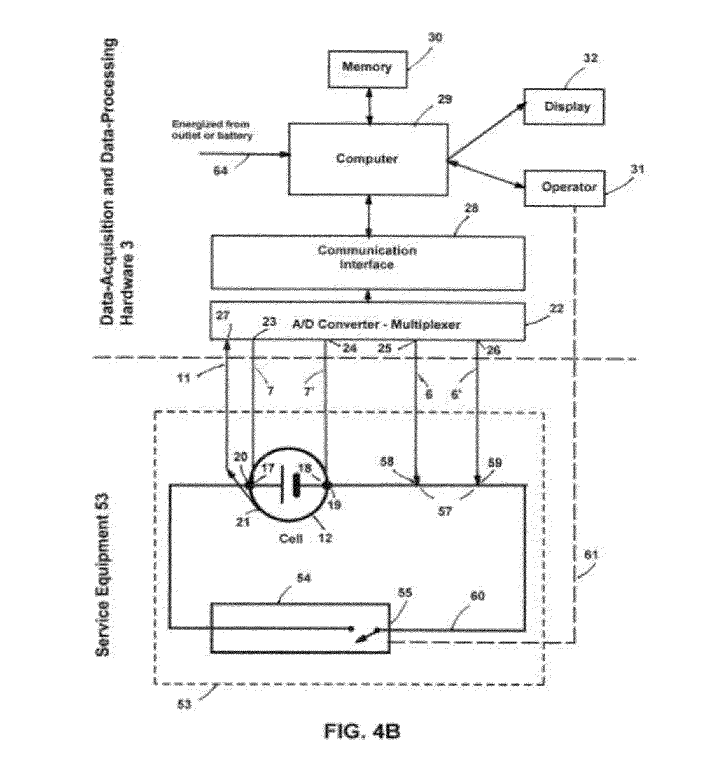

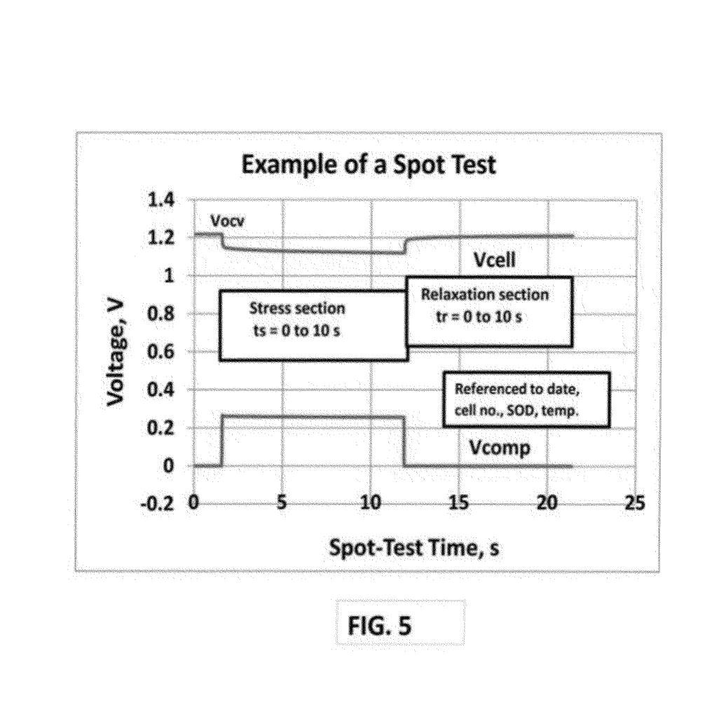

### Additional Numerals in FIG. 4

53 Service equipment
54 Service load
55 On-off switch for service load 54
56 Current-carrying cable between switch 5 and service-load switch 55
57 Section of cable 56 used as alternative comparator resistor
58 Voltage lead 6 connection to alternative comparator resistor 57
59 Voltage lead 6′ connection to alternative comparator resistor 57
60 Current-carrying cable within service equipment 53.
61 Manual control of the service-load on-off switch 55
62 Holder of cell 12 (shown in FIGS. 1, 2, and 3)
63 Compensator voltage source (shown in FIG. 1A)
64 Energized from outlet or battery (shown in FIGS. 1-4)

### Numerals Used for Software Operations

66 STs
67 STpd
68 STd-c
69 STotf
71 STR-measured
72 STR-processed
73 STR-t-based
74 TDPPS table format
75 TDPPS line format
76 STDB Spot-Test Data Bank
77 MTD Master Data Tabulation
78 TD-PDPPS
79 Family of MDT-s
80 Atlas of MDT-s
81 PCD Performance-Capability Diagram
   Symbols as Used in this Invention Description
Ah ampere-hour
As ampere-second
Co centigrade
Nominal Ah/cell is a nominal cell capacity value as defined by the manufacturer
SOC state of charge indicates cell state as Ah/cell charged
SOC % cell state relative to nominal cell capacity
SOD state of discharge indicates cell state as Ah/cell discharged
SOD % cell state relative to nominal cell capacity, SOD %=100−SOC %
C a nominal practical value of current needed to achieve full charge or discharge capacity within an hour. C refers to an actually measured capacity (Ah) in a completed discharge half-cycle.
C-rate an approximate practical momentary value indicating cell-current normalized for a 1 C-rate current, e.g., 0.1 C.
Cy# cycle number
d difference
IMP impedance, ohm/cell
IMPs impedance measured during a stress section of ST
IMPr impedance measured during a relaxation section of ST, a virtual value
Polarization: dV value, e.g., dVs=Vocv−Vcell, dVr=Vcell−Vs,last
R resistor or its value in ohms
Rcomp comparator resistor 4 or its value in ohms
s measures second
s as a subscript, indicates stress section
t time in a ST section, second
tr time in a relaxation section
ts time in a stress section
Temp temperature
V voltage
Vcomp voltage measured on a comparator resistor
Vocv stabilized cell voltage on open circuit
Vr cell voltage measured during relaxation section of a ST
Vs cell voltage measured during stress section of a ST
Vs,last the last voltage reading before the circuit opened, at tr=0 sec time
Vr,last the last voltage reading before the circuit closed, at ts=0 sec time
dV Used for impedance calculation, it is used as a positive value for both stress and relaxation. See: polarization
vs versus
W watt, unit of power
We cell's power, watt/cell
   Acronyms Introduced for this Invention Description
MDT Master Data Tabulation 77 for TDPPS entries (see: Table 2)
PCD Performance-Capability Diagram 81
PD Power domain
PP Performance Parameter (such as impedance/cell and power/cell)
PDPP Power-Domain Performance Parameter
PDPPS Power-Domain Performance Parameter Set
SOH State of Health of a cell
ST Spot Test
STs Single load-step Spot Test 66
STpd Power-domain Spot Test 67
STd-c Four-section discharge-charge Spot Test 68
STotf Spot test on-the-fly 69 is an ST super-imposed on a standard test
TD Time domain
TDPP Time-Domain Performance Parameter
TDPPS Time-Domain Performance Parameter Set 74 and 75 (see: Table 1)
TD-PDPPS Time-Domain and Power-Domain Performance Parameter Set 78

### DESCRIPTION OF THE INVENTION

### Embodiment 1

A typical basic embodiment of the measuring apparatus 1 is illustrated in FIG. 1. Two basic components of the invented apparatus 1 are a test circuit named spot-test hardware 2 (STH 2) and a data-acquisition and data processing hardware 3 (DPH 3) as shown in FIG. 1. Hardware 2 and data-processing hardware 3 are shown separated by a broken line. Hardware 2 and 3 works interactively with each other, and cell 12 and operator 31. Hardware 2 and hardware 3 are enclosed in (a) either a common case (not shown in FIG. 1, being a common practice and obvious) or (b) hardware 2 is in a case and hardware 3 components are commercial items.

### Spot-Test Hardware 2 (STH 2)

Spot-test hardware 2 (FIG. 1) includes a comparator resistor 4, an on-off switch 5, current-carrying connecting cables 8, 9, and 10, a pair of voltage-measuring twisted leads 6 and 6′ connected to comparator resistor 4, a pair of voltage-measuring twisted leads 7 and 7′ used to measure voltage of a cell to be tested, and a temperature sensor 11, e.g., a thermocouple. A thermocouple includes an ice-point at connection 27.

FIG. 1 shows apparatus 1 when a cell to be tested (in this case cell 12) is placed in holder 62, electrically connected, and ready for a test measurement.

The comparator resistor is connected to the current-carrying circuit by cables 8 and 9. Twisted voltage-measuring leads 6 and 6′ of resistor 4 are connected to A/D converter-multiplexer 22 at electrical connection points 25 and 26 providing voltage inputs for Channel 1 of converter 22. The usual four-point connection principle is applied for comparator resistor 4 at voltage leads connections 13 and 14, and current-carrying cable connections 15 and 16. The four-point connection is very important to ensure precise resistance and impedance measurement. A comparator resistor (such as resistor 4) has to be a pure resistor by its construction. That is free of capacitive and inductive components (having a time constant in the microsecond range). A coil resistor is not acceptable. Resistance of resistor 4 must be constant, not affected by temperature variations (i.e., has a low temperature coefficient). The ohm value of comparator resistor 4 must be precisely known (preferably, within 1% precision or better). The comparator resistor's wattage specification must be met to avoid over-heating even at the highest expected current. The highest current for a spot test (ST) is generally higher than the current of 1 C-rate of discharge. The highest current is limited by the sum of the resistances of comparator resistor 4 and current-carrying cables 8, 9, and 10. Resistor 4 is exchangeable to permit to set an appropriate C-rate. Resistor 4 should have a resistance value that produce well-measurable IR-drop, preferable in the 10 mV to 1 V range.

Hardware 2 is constructed so that the basic circuit elements (4, 5, 8, 9, and 10) do not have significant capacitance and inductance components. Only cell 12 has RCL components in the circuit to ensure un-ambiguous results. (The RCL acronym is used for collective designation of the resistive, capacitive, and inductive components of an electrical circuit.) This criterion should be documented by calibration (as described in the Test Operation section).

Cell 12 is connected to apparatus 1 with two current-carrying cables 8 and 10, and the two twisted voltage leads 7 and 7′. The four-point connection principle is applied to the cell's connections. That is, two current-carrying cables 8 and 10 are connected at points 19 and 20; and two voltage leads 7 and 7′ at points 17 and 18, respectively. Connections 17 and 18 should be right on the cell's terminal's body, not on connections 19 and 20.

Temperature sensor 11 is attached to cell 12 at attachment point 21 thermally well-connected, but, electrically isolated. The sensor's signal lead is connected to the A/D converter 22 at connection point 27. Connection 27 is the input to Channel 3 of converter. Sensor 11 can be a thermocouple. The thermocouple's sensing end is fixed by adhesive tape and some thermal-compound under it to ensure good thermal conduction. If cell 12 is visually accessible, sensor 11 can be an infra-red thermo sensor.

Cell 12 is in an appropriate holder 62 either alone or as part of a battery pack. Holder 62 is either part of the apparatus (e.g. for smaller cells) or a stand-alone component. Details of the holder are not shown in FIG. 1 being its function obvious. Nevertheless, the holder has to provide adequate mechanical stability and allow good thermal equilibrium between the cell and its environment. Actually, cell 12 is not part of apparatus 1; it is the subject of the tests.

Switch 5 closes and opens the measuring circuit. Its main features include low resistance and very short switching time, preferable in the micro-second range. Switch 5 is operated by either communication interface 28 through a control lead 33 or manually 34 by the operator of the test 31.

Electrical noise problems are reduced by the arrangement of embodiment 1 (and by the other embodiments, too). Pared voltage leads 6, 6′ and 7, 7′ are twisted and can be shielded. No noise-prone components are in the circuit. Effect of electromagnetic radiation noise sources is minimized by twisted leads (6, 6′ and 7, 7′) and the comparativeness of the voltage measurements.

Data-Acquisition and Data-Processing Hardware 3 (DPH 3)

The upper part of FIG. 1 shows the data-acquisition and data-processing hardware 3. Hardware 3 includes an A/D converter-channel multiplexer or independent A/D converters for each channel synchronized together 22, a communication interface 28, a computer 29, a data-storage memory 30, and a display 32. The computer term here is used in generic sense. Any computing device capable of performing the required task satisfies. Computer 29 interacts with communication interface 28, memory 30, and display 32. Voltage leads 6, 6′, 7, 7′, temperature sensor lead 11, and controls 33 and 34 provide functional connection between spot-test hardware 2 and hardware 3. A/D converter 22 has high input impedance, preferably 10 Mohm or more for each channel. Voltage leads 7 and 7′ are connected to Channel 1 of converter 22, leads 6 and 6′ to Channel 2, and temperature sensor lead 11 to Channel 3, respectively. All these leads are floating, i.e., are not connected to system ground or together at any point. Hardware 3 is energized from a wall outlet or preferably by an energizing battery (not shown in the figure) for being able to perform a completely independent field testing.

FIG. 1A shows a voltage compensation voltage source 63. Voltage source 63 consists of cells having a stable voltage down to +/−0.1 mV precision over an hour or longer time period. Voltage source 63 is simply a set of commercial alkaline manganese dioxide cells, e.g., 1.5-V AAA size and/or 9-V serially connected plurality of cells according to the needs of Channel 1 measurement. Voltage source 63 is connected between 17 and 23 points with counter polarity to cell 12 (i.e., the positive of 63 is connected to the positive terminal of cell 12 at 17). Purpose of this arrangement is to reduce the actual input voltage to Channel 1 and, thus, improve precision of readings of low values. Thereby eliminating the need for auto-ranging of the A/D converter. For example, a 9-V cell can be used as voltage source 63 when a 12-V battery is tested. The exact value of the selected set-voltage of source 63 must be precisely calibrated as explained in the Test Operation Section below. Arrangement of FIG. 1A is optional, but is very useful for testing batteries of higher voltages (6 V or more, up to 48 V), for example, in Examples 2 and 3. For human safety reasons Apparatus 1 is designed to operate up to 48 V DC. In the battery operated version, no AC is present in the measuring system.

Software of Measurement and Data Processing

Operator 31 determines the test procedure and schedule pattern, initiates the spot-test through computer 29 and communication interface 28 by sending signals through lead 33 to operate switch 5. The operator may control switch 5 manually 34. By operation 33 or 34, the operator initiates a spot test 66, 67, 68, and 69. The term spot test is used in this invention description to distinguish it from other types of various battery-cell testing procedures, for example, from a standard charge-discharge cycling test. After initiation, the spot-test process proceeds through several data-processing stages. The ST data-processing stages are

STR-Measured 71

A spot-test record as measured 71 (approx 1-2 MB), includes

(a) Measured values, such as Scan No., Time, Cell V, Vcomp, temperature and

(b) Identifiers, such as Cell #, ST type, etc. (defined below).

Each Scan No. represents a sampling-time interval of A/D converter 22. Time is calendar time.

A STR-Processed 72

Processed spot-test record 72 (approx. 1-2 MB), includes

Scan No., Time, s, ts, tr, log t, Cell V, Vcomp, A, W, Temperature and identifiers

s is test time, ts and tr is stress- and relaxation-section time, respectively.

STR t-Based 73

A spot-test record based on section time (ts and tr) (approx. 1 MB), includes

Time, t, log t, Vs, Vcomp,s, W, Vr, Vcomp,r, dVs, dVr, Temperature and identifiers.

The s and r subscript refer to the stress and relaxation section, respectively.

TDPPS table format 74 (approx 40 kB), shown in Table 1.

TDPPS 75 Time-Domain Performance Parameter Set 75 (approx. 20 kB).

(a) TDPPS 75 is the final data format for a spot test stored in memory 30. TDPPS is a single line entry in spreadsheet format and consists of three different types of parameters such as identifiers, measured performance parameters, and derived, calculated performance parameters as specified in the Operation of Invention section.

STDB 76 Spot-Test Data Bank. Individual TDPPS 74 and 75 records, and TD-PDPPS 78 records are collectively stored in memory 30 for later recall and analysis.

Also, shown are the approximate computer memory needs of the associated data to appreciate the effect of data reduction from stage 71 (1-2 MB) to stage 75 (20 kB). The data reduction does not diminish the quality of information at all. Data of stage 75, the TDPPS actually contains all pertinent information of the ST that the STR-measured stage 71 does plus the processed performance parameters in a new, specific format. This, in fact, underlines the power of the Time-Domain Performance Parameter Set concept. Stages 71, 72, and 73 are shown only for illustration. Only the spreadsheet type files of stages TDPPS table format 74, TDPPS 75, STDB 76, and MDT 77 are stored permanently in memory 30. Data in 74 and 75 formats are equivalent. They can be converted to each other. However, format 74 and 75 serves different purposes. Format 74 is used for immediate charting and evaluation, while format 75 being a part of STDB 76 or MTD 77 for comparative performance analysis. Operator 31 may recall files of TDPPS, MTD, and STDB from the memory 30 for evaluation on display 32.

The invented data-processing method as proceeds through stages 71, 72, 73, 74, and 75 is applicable to any other step-signal type documentation. This data-processing method is characterized by the ability to compress large linear-time scale files to a small file of a precise data set in the log-time time-domain, like the TDPPS. The TDPPS exactly describes the original plot with data that can be used in a wide-variety of calculations, and are ready for mathematical and visual representation.

Communication interface 28 may function the following ways: (a) Transmits digitized data from converter 22 to computer 29. (b) Blocks the ST measurement at switch 5 if the conditions are not right. They are not right if cell voltage is not stable (more than 1 mV/min change) or cell temperature in a transient (more than 1 Celsius/min change). (c) Indicates the reason of blocking on display 32. (d) Signals the green way for the ST. (e) Directs to close and open switch 5 through lead 33 according to a timing schedule determined by the operator. Other functions of interface 28 are part of Embodiments 2, 3, and 4. These are (f) Operates a contact selector 42 of FIG. 2 through line 35 of FIG. 2 according to a test schedule determined by the operator. (g) Operates a charge-discharge switch 47 of FIG. 3 by lead 51 according to a timing schedule determined by the operator.

The components and operations of Embodiment 1 are included in more complex spot-test measurements as shown in Embodiments 2, 3, and 4.

### Embodiment 2

Embodiment 2 of the invention is shown in FIG. 2. Embodiment 2 is a general setup designed to carry out various spot test measurements such as STs 66, STpd 67, and MTD 77 generation. Using Embodiment 2, several ST measurements can be combined together due to the plurality of resistors (by number and resistance) included in selector switch 37.

In addition to components shown in FIG. 1, apparatus 1 includes a selector switch 37. Selector switch 37 consists of a resistor set 38 and a contact selector 42. Resistors RA 39, RB 40, and short 41 are connected to the circuit alternatively by contacts 43, 44, and 45, respectively. RA and RB are load resistors used to set certain current loads defined by C-rates. For example, to cover a 0.1 C to 10 C range. Comparator resistor 4 has the same function as in Embodiment 1.

For an STpd 67 test, the numerical value of RA is selected so that the sum of the resistances (39, 4, and cables) set an approximately 0.1 C-rate current. RB and short (i.e., no resistance at this connection point) should set about 0.5 C and 1 C current, respectively. Alternatively, for more aggressive STpd C-rate sets may be chosen (for example, 10 C, 1 C, and 0.5 C). Contact positions 43, 44, and 45 are set either manually 36 or by control line 35 from communication interface 28 according to a STpd test schedule. Closing and opening of switch 5 starts a stress and relaxation section pair, thus generates a TDPPS 75 for that particular C rate. Successive C-rate settings generate TDPPS 75 lines of a power-domain test TD-PDPPS 78. Switch 5 is operated either through lead 33 from interface 28 or manually 34 by the operator.

Each resistor at locations 39, 40, and 41 is exchangeable for selecting appropriate C-rates in any combination. However, all resistors included in selector switch 37 should be pure resistors. Only the test cell may have capacitive and inductive electrical response signal components in the whole circuit. This situation must be confirmed by calibration. The calibration is described in the Test Operation section.

### Embodiment 3

Embodiment 3 illustrates a discharge-charge spot test, STd-c 68. FIG. 3 shows the apparatus used for embodiment 3. In addition to components shown in FIGS. 1 and 2, hardware 2 includes a charger 46, a discharge-charge switch 47, connecting cables 48, 49, and 50, control leads 51 and 52. Charger 46 is usually a regular commercial charger specified to the type of cell 12. However, chargers may introduce electrical noise problems and somewhat distort the test cell's own charge stress response. To eliminate this problem, a charger battery-cell may be used as a charger. If a charger cell (at position 46) is used, it should have, preferably a 5-times higher rated capacity and a 0.5 V or a somewhat higher voltage than those of the test cell. The high capacity of the charger cell and, consequently, relatively low (negligible) power-domain impedance (vs the test cell) ensures that the measurement is valid for cell 12. The positive terminal of cell 12 and that of charger 46 or the alternative charger cell are connected together. The C-rate of charge and discharge can be set independently by choosing proper values for resistors 39 and 40, and contact positions 43, 44, 45.

The STd-c type spot test is especially useful for testing batteries used for hybrid car applications.

### Embodiment 4

Embodiment 4 describes a case when the cell under test is in a service-equipment 53. FIG. 4A and FIG. 4B shows two different methods for connecting apparatus 1 to the service-equipment.

FIG. 4A shows when comparator resistor 4 and switch 5 are inserted in the circuit of service equipment 53. Resistor 4 is connected by cable 8 and switch 5 by cable 56. However, for large equipment and high-amperage batteries, this method is less advantageous as method of FIG. 4B, because of the need for heavy components (4 and 5).

FIG. 4B shows the preferred method. The service equipment's circuit includes cell 12, cable section 57, connecting cable, service load 54, and a service-load switch 55. Advantages of this spot-test arrangement are (a) the load circuitry is ready in the service equipment, (b) the service equipment provides the appropriate current range for the test, (c) very high-capacity (heavy cell/battery) and high-power (high amperage) cells can be tested without the need for building an apparatus 1 with heavy components and thick cables, (d) a high-amperage switch 55 is already available in the service equipment. This arrangement works especially, if the service equipment provides an opportunity for finding and using a resistor as comparator within its own circuitry. As shown in FIG. 4B, an appropriate section of the current-carrying cable 57 serves as comparator resistor. Then, Vcomp leads 6 and 6′ are connected to this cable section at connecting points 58 and 59. Even switch 5 can be omitted. Then, the operator 31 manually operates switch 55 to initiate an ST. Cable section 57 should satisfy the requirements of a comparator resistor (pure resistor, constant resistance). The resistance of section 57 should be calibrated with an appropriate ohm-meter.

Embodiment 4 provides means for a special type of TDPPS measurement. Namely, the open-circuit starting point requirement of the ST measurement is relieved and a load step is used instead. The evaluation follows the same, regular routine.

Operation of Invention

The following description of the operation explains a spot-test measurement referring to FIG. 1 and Embodiment 1. The procedure equally applies to primary and rechargeable cells. The operation is carried out along a chain of protocol steps such as

(a) recording cell and test identifier data in file by operator 31; the identifiers include File number, Cell No., at Calendar time, at Vocv, C-rate, ST type, temperature, Rcomp, load, scan interval, cell chemistry, cell model, nominal Ah capacity, and at Ah, at SOD %, and cycle number if they are known,

(b) determining the kind of spot test to be executed,

(c) determining the number of section-time decades and set the sampling rate of converter 22 accordingly,

(d) installing a resistor 4 of proper resistance value to produce a selected C-rate; connecting cables 8 and 9, and voltage leads 6 and 6′,

(e) determining the test schedule (on and off t-times),

(f) placing test cell 12 in holder 62,

(g) connecting current-carrying cables 8 and 10 to test cell 12,

(h) connecting voltage leads 7 and 7′ to test cell 12,

(i) installing a voltage compensator source 63, if needed,

(j) attaching temperature sensor 11 to test cell ensuring good thermal coupling and perfect electrical isolation 21,

(k) pre-test monitoring of cell voltage and temperature,

(l) observing (on display 32) that the cell conditions are right for the test. That is, cell 12 has a well-settled, stable open-circuit voltage (Vocv is changing less than a 1 mV/minute) and the temperature of cell is not shifting more than 0.2 Celsius per minute. If the cell is in a service equipment, selecting the proper section of the duty cycle.

(m) initiating the test by computer 29 through lead 33 or manually 34,

(n) completing the test by examining that the TDPPS file correctly stored in memory 30.

Several aspects of the spot-test operations are explained below.

Pre-Test Voltage and Temperature Monitoring

A pre-test monitoring of the voltage and temperature of cell 12 important to confirm the right test conditions and measure Vocv. The right conditions are (a) less than 1 mV/min change of Vocv and (b) less than 0.2 celsius/min shift of cell's temperature. These conditions are monitored on display 32. Seeing the right conditions, operator 31 may decide to initiate the test. Even so, operator 31 may relieve the need for continuous fast recording the temperature. Then, the operator just includes the stable temperature value among the test identifiers. This is permissible because the ST is short and even the highest C-rate does not cause significant, measurable temperature change within the short duration of the test. It is advantageous to run the test with only two channels with fast monitoring (sampling time is 0.01 s or less). Channel 3 is for temperature monitoring. Following from the nature of the A/D converters, this practice permits faster and more precise measurement in the active channels. Nevertheless, continuous monitoring of the temperature of cell 12 is mandatory when MDT 77 is being generated or temperature and calorimetric effects are investigated. The right conditions for the ST may be considered differently as described in Embodiment 4.

Calibration of Apparatus

The time-domain measurement of a cell (as stated in this invention description) is precise if only the tested cell/battery has RCL components in the electrical circuit. Calibration of the apparatus is important to document this condition. Calibration refers to Embodiments 1 and 2. Circuits of Embodiments 3 and 4 may include CL-active components in addition to R components. However, this is considered as part of the measurements with Embodiments 3 and 4.

Calibration of Embodiment 2. Cell 12 is omitted and a certified square-wave generator signal is applied between connections 19 and 20. The square-wave signal across a pure resistor should have a time constant of less than a few micro-seconds. When the square-wave signal is applied, voltage response-signals are measured in channels 1 and 2 of converter 22. Record of channel 2 is for resistor 4 and that of channel 1 is for all components of the circuit. Channel 1 readings specify circuit components such as 8, 4, 9, 5, 42, resistors of 37 (measured for each setting individually), and 10. The time constant indicated by readings of channel 1 should be less than that of the fastest decade of the ST measurement.

Test is Self-Energized

The ST measurements of this invention are self-energized. Cell 12 itself provides the current, which generates the voltage response signals Vcell and Vcomp for recording and analysis. This is important for several reasons. The test cell works under its normal condition. The test cell is the energy provider similarly to its own application mission. No art effects are involved. The conventional testing instruments, unless they are high quality, may carry over their own load response profile in the time domain, thereby modify the cell's response. Wall-outlet operated instruments may introduce electrical noise and distort the time-domain response. Unlike the high-quality, complicated testers and cyclers, the invented apparatus can be produced quite inexpensively.

The invented method is universal for any cell chemistry, type, size, shape, and battery application scenario.

Spot Test

Any single measurement action carried out by the apparatus 1 is termed spot test (ST). The spot test term is a generic one in the context of this invention. The ST term refers to its function: measuring instantaneous characteristic properties of cell 12 at any given time. The final result of the ST is a TDPPS data set, which is stored in memory 30. The ST term is used to distinguish it from other kinds of cell testing procedures. The ST is based on the fact that the voltage response of a pure resistor (such as comparator resistor 4 in FIG. 1) and that of an RCL device (such as cell 12) is different when a fast load-change is applied (for example, when closing, then opening of switch 5). Load increase causes a stress condition, while load decrease a relaxation condition. Pairing a stress-section with a relaxation-section is an important feature of the spot test. Depending on how a load-change applied different types of ST are available. The invented method defines the following types of the spot tests.

(a) STs 66 is a single load-step test, FIG. 5 shows an example chart for an STs.
(b) STpd 67 is a power domain test including two or three consecutive step-up loads,
(c) STd-c 68 is a four section discharge-charge test,
(d) STotf is a spot test on-the-fly.

Spot testing and its procedure equally applies for primary and rechargeable cells. The cycle number (Cy#) or use-time is an important identifier for a spot test of a rechargeable cell. Cy# and use-time relate to cell's age. However, for the purpose of a spot test procedure, a rechargeable cell in any cycle is treated as it is for a primary cell.

The spot test generates a time-domain performance-parameter set, TDPPS 74 and 75, which are, then, stored in memory 30 of apparatus 1. TDPPS 75 is the final data format stored in memory 30. TDPPS 75 is a single line entry in spreadsheet format.

The TDPPS 75 comprises several aspects of battery/cell state evaluation. By a single spot test as many as 41 parameters can be measured if a 4-decade measurement (1-ms sampling time) is executed. This spot test example consists of a 60-s long pre-measurement period (for evaluating the test-cell stability by measuring Vocv and temperature change), a 10-s long resistance-load stress period (to evaluate power capability and impedance in the time domain), and a 100-s long open-circuit relaxation period (to evaluate the cell's recovery capability). Parameters of this example TDPPS include

2 pre-test values (Vocv and temperature change);

18 identifiers to document the circumstances of the spot test (these are Filename, Cell No, Time, Ah if known, SOC % if known, Vocv, Temperature, Rcomp, C-rate, Measurement type, Load, Scan interval, Cell Chemistry, Cell Model, Nominal Ah, Pre-V, Test notes, Purpose);

12 directly measured values (4 IMPs, 4 IMPr, 4 power values);

9 characteristic, calculated values (including IMP and W slopes between decade values, heat parameters, voltage values).

Spot tests can be executed different ways. For example, less parameters, more or less time-domain decades or calculated parameters, accordingly, the TDPPS 74 and 75 may be somewhat different.

The TDPPS lines can be compared either directly to each other to find change in the battery state or to the pertinent Master Data Tabulation (MDT)

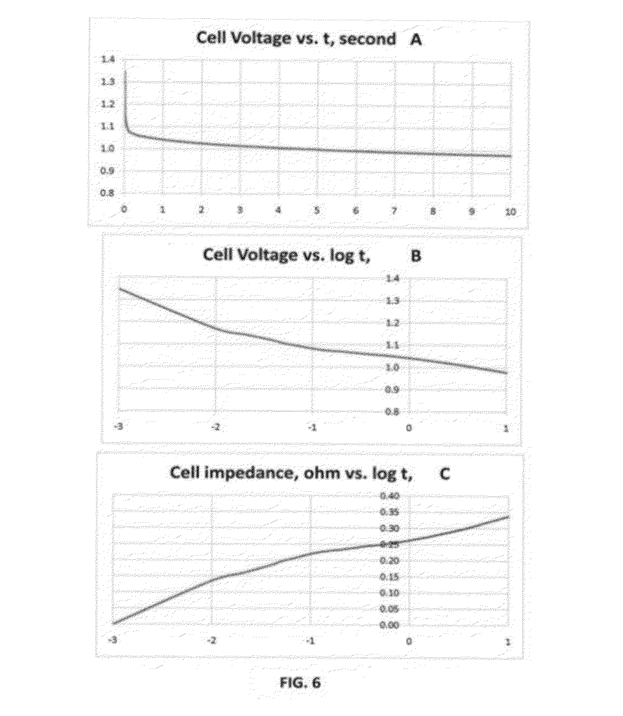

In its generic sense, the performance parameter's time-domain specifies a TDPPS which is referenced to the actual time-range of the spot test. As in the above example, an ST may be recorded in the 1 ms to 10 s time range, i.e., the sampling time in converter 22 is set to 1 ms. In this case, a test covers four decades and the time subscripts are 0.01 s, 0.1 s, 1 s, and 10 s. This case is shown in FIG. 6C. Use of log-10-based time ranges, decades is convenient for human perception. FIG. 6C shows an example. In ST shown in FIG. 6, plot B reveals break points on the curve. The break points coincide with decades. Therefore, the performance values are organized accordingly. This coincidence is not a rule. In another case, a chart of cell voltage vs log t may reveal break points at different t times. Nevertheless, this type of chart, the STR-t-based 73, usually shows linear sections between brake points. The STR-t-based charts such as shown in FIG. 6B provide useful information about the cell's electrochemical processes. This phenomenon supports the idea of electrochemical processes and time constants relationships (as explained below).

Section Times of a Spot Test

The stress and relaxation sections have their own time scale (section time, ts and tr) in seconds starting at the moment when switch 5 closes and opens the circuit. Consequently, a spot test (STs) has two sections, during which hardware 3 measures and analyzes the voltage response data. Four sets of voltages are measured and analyzed on the section-time scale such as cell voltage Vs,t and comparator voltage Vcomp,s,t in the stress section, and Vr,t and Vcomp,r,t, in the relaxation section, respectively. The t in the subscript shows the section time in units of second.

Specifying Time-Domain Impedance, IMPs

The time-domain impedance is the most important quantity to be measured in a spot test because its magnitude and pattern of change along the section-time scale sensitively relate to the cell's state. The cell's impedance in the stress section is calculated by

IMPs,t=[(Vocv−Vs,t)/(Vcomp,s,t]Rcomp [Eq. 1]

Where t designates the section time measured from the moment when Vocv starts changing to Vs,t, i.e., at t=0 sec, Rcomp is the resistance of the comparator resistor. Cell's impedance is measured in ohm/cell units.

Eq 1 shows that the spot test is a comparative measurement. The comparativeness ensures that any change in the current intensity during the test does not affect the impedance calculation. The current changes during the test due to the fact that the Vcell changes but the load is constant. The voltage of cell 12 and the synchronously measured voltage drop on comparator resistor 4 are compared. This feature of the ST advantageously diminishes or even eliminates noise problems of the voltage measurement.

### Specifying Relaxation-Section Impedance, IMPr

For the relaxation section, a virtual impedance is defined (IMPr,t). The rationale for this idea is the association of relaxation with a current flow within the cell that is trying to equalize the stress-created local conditions. This current is called in-cell equalization current. The in-cell equalization current is a short-circuited situation within the cell and cannot be measured directly. Supposedly, in a healthy cell, the equalization current flows with the same intensity as the one created the inequality. The relaxation-section impedance is calculated as

IMPr,t=[(Vr,t−Vs,last)/Vcomp,s,last]Rcomp [Eq 2]

Where Vs,last and Vcomp,s,last are the last values measured under current flow in the stress section. Vcomp,r,t is zero in the open-circuit relaxation section.

The present invention uses a data processing scheme to quantitatively describe a stress or relaxation section. FIG. 6 illustrates this process for a stress section. The first plot (FIG. 6 A, cell voltage vs second) shows how the voltage values are measured and recorded on linear time scale. To obtain a sufficiently detailed information, the voltage is recorded, say, 1 ms time resolution (1-ms sampling time of the A/D converter 22). Consequently, the whole plot has 10,000 data points. However, we cannot see too much features of the curve visually. On the other hand, a logarithmic-time scale representation dramatically changes the visual appreciation, as shown on the second plot (FIG. 6B). Features appear on the log-time scale as. These features are clearly discernible as curvatures at breakpoints. FIG. 6B shows the break features at 0.01, 0.1, and 1 s. Depending on the type and chemistry of the cells the features may appear at different time domains. FIG. 6C shows the associated time-domain impedance as calculated by Eq 1. Time resolution of the measurement (A/D sampling rate) particularly at the beginning of a load or relaxation period has a certain influence on the preciosity of the results; however, a sampling rate of 25 ms allows well usable estimations, while a sampling rate of 50 ms is still usable in most cases. A sampling rate of 1 ms or 0.1 ms may even allow a sensitive quality control during manufacture.

A 10-s and 10-s long recordings in two channels at 1 ms resolution contain 40,000 data points. The large memory space needed could be over-whelming for memory 30. The invented method uses a data-reduction scheme. The software selects voltage, power, and impedance values only at the designated log-scale break points and/or decade-time points and condenses them to the TDPPS data set. The generic TDPPS refers to time-domain decades (shown by subscripts). A TDPPS data set needs only about 20 kB memory space. The invented drastic data reduction technique, however, does not compromise the integrity, quality and precision of the spot test record.

First Valid-Decade Concept

A key feature of the data processing is identifying the first data line at t=0 time (in a spreadsheet of STR t-based 73). How to identify the first data line and the start of the stress or relaxation section needs clarification. At t=0 s section time, comparator resistor 4 indicates an abrupt change of the Vcomp for both the stress and relaxation section. For a linear-time scale, this is a good indication. However, on a logarithmic-time scale, defining the first V or IMP value is not straightforward. Therefore, introducing conventions is necessary. First convention is that at Vocv an impedance value cannot be specified. FIG. 6C shows Vocv at log s=−3 because a 1-ms sampling time was used. This is a rather arbitrary choice, but necessary because a log-time scale has no zero-time value. Second convention is the definition of the first-valid log scale data. The first-valid-data point on the log-time scale, generally, is not the first measured point after closing the circuit at switch 5. A couple of reasons are involved. First, perfect synchronization of sampling of A/D converter 22 with switch 5 is very difficult (it would need expensive instrumentation). Second, a switch has a switching time within which the real current flow is uncertain. Depending on the quality (and price) of the switch, the switching time and the associated false record is in the 1- to a couple-of-hundred microsecond or even longer range (depending on quality of switch). To eliminate these effects from the TDPPS, as a rule, only the 5th or—even better—the 10th digital sample (after the voltage transient detection) is accepted as a valid record. For example, if the sampling rate is 1 ms, the first valid logarithmic-time decade starts at −2, i.e., at 0.01 s, FIGS. 6B and 6C. However, a 0.01-s sampling rate is acceptable for most ST measurements. Namely, it has been found that the 0.1- to 10-s time range is the most indicative for a TDPPS. Nevertheless, testing down to shorter time decades are required for cells that are used in pulsing or very dynamic applications or for ultracapacitors. Then, the components of the apparatus have to be selected accordingly.

Time-Domain Power

The cell impedance is indicative of the polarization-related losses that the cell suffers during a perturbation event. However, the measured voltage signals carry even more information than just impedance. Time-domain power is the product of Vs,t and Vcomps,t/Rcomp. (Vcomps,t/Rcomp is the current at t time).

Wt=Vs,t(Vcomp,s,t/Rcomp) [Eq. 3]]

TDPPS 74 and 75

The spot test generates time-domain performance parameter sets, TDPPS 74 and 75, which are, then, stored in memory 30 of apparatus 1. TDPPS 74 and TDPPS 75 have the same data, in two different formats, table and line format, respectively. TDPPS 75 is the final data format stored in memory 30. TDPPS 75 is a single line entry in a spreadsheet format.

The TDPPS includes slope calculations from impedance- and power-decade values. Data-processing of this invention has revealed the significance of slope calculations. Considered in time domain slopes of impedance and power across the time domain are sensitive indicators of cell's states.

Power-Domain Spot Test, STpd 67

A power-domain spot test, STpd 67 generates a set of impedance and power values that are measured at consecutively increased C-rates. The result is a time-domain and power-domain performance-parameter record, TD-PDPP 78. The operation is executed by Embodiment 2. The Vocv applies only to the first step. The consecutive steps start from a different V value. This difference carries additional information of cell's state. A TD-PDPPS is different from a combination of 3 individual STs tests at different C-rates. In a STpd, the stress sections (except the first one) start at a less-relaxed state.

The resistance values: Rcomp, RA, and RB are selected so that the currents of consecutive stress-sections may cover decades of the C-rates, e.g., from 0.1 C to 10 C. Testing for very-high power applications in a wide dynamic range, the rates should cover a 1 C to 10 C decade. The STpd should not change the cell's state at even the most stressing range. Therefore, even the highest-rate step should not discharge more than one percent of the cell capacity. For example, at 1 C the stress section should be limited to 10 s and to 3 s at 10 C.

Discharge-Charge Spot Test, STd-c 68

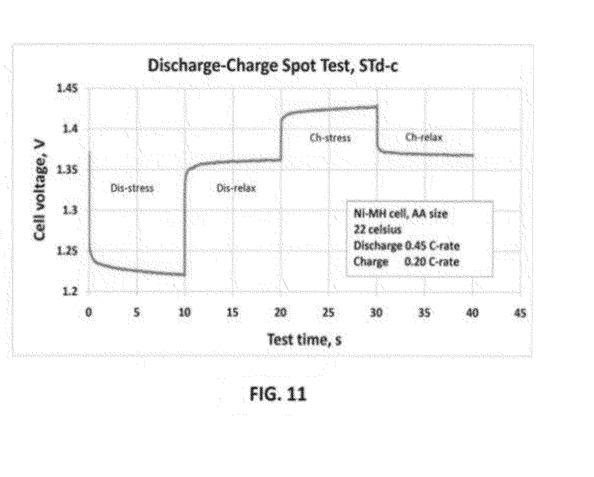

The STd-c test procedure can be used for spot-testing rechargeable cells to determine cell's state discharge parameters and also charge-rate capability (charge up-take capability). The charge-rate capability relates to cell's impedance at a specified C-charge-rate (referenced to nominal full capacity, Ah/cell). Consequently, the STd-c is a four-section spot test, shown in FIG. 11. Two pairs of sections are Dis-stress, Dis-relax and Ch-stress, Ch-relax. STd-c test of an AA-size Nickel-Metal-Hydride cell is described in Example 3.

Spot Test on-the-Fly 69

Spot test on-the-fly is carried out during the normal operation of the battery/cell. The apparatus is attached to the circuit of the service equipment and for a predetermined time either opens the circuit or applies a load resistor (in addition to the already existing resistive elements of the circuit), thereby, generating a sharp change of the cell's load. In certain cases, the service load schedule itself includes sharp changes of the load on the cell. Then, this service load sections can be used to initiate the spot test. The circuit scheme of this measuring method is illustrated in FIG. 4A and FIG. 4B.

Spot Test and Electrochemical Cell Processes

The logarithmic-time scale representation of the cell voltage, impedance, and power in time domain, as used in the invented method, carries a lot of scientific and technical merits.

It is a commonly accepted, that the electrochemical processes in a cell occur or dominate in certain sequential time (time-domain) ranges as a response to a perturbation. Qualitatively describing, the electrochemical processes cover a very wide time-domain range from 1 micro-second to multiple minutes as they progress though ohmic, charge transfer, mass-transport, and solid-state diffusion processes. Although this simplified description is very crude and does not account for the actual chemistries, structure, and morphology of the cell constituents, yet provides a general guideline to associate the log-time-range indicators with the nature of the underlining electrochemical cell processes.

The time-domain measurement method of this invention distinguishes ranges in the time domain qualitatively characterized by the rate of the involved processes. These ranges are (a) ohmic related superfast, (b) fast, (c) medium, and (d) slow. The four ranges can be associated with the electrochemically characterized processes described in the same order above. The range distinctions relate directly to battery development and application technology issues. Each of the shown time ranges can be associated with a time-domain range, a time decade on the logarithmic timescale as discernible in between break points or in log-time decades in FIG. 6 C.

From the electrical point of view, each decade can be associated with a time constant of an RC circuit. Consequently, the cell can be visualized as serially connected RC circuits of increasingly higher time constants. The time constant is an important parameter considering the electrical (rather than chemical) nature of the battery application. The time-constant association concept leads to a simple, effective electrical modeling application of the TDPPS.

There are other laboratory techniques available to determine correlation between impedance and electrochemical processes. For example, AC-impedance, frequency-domain methods are used successfully to measure cell impedance in characteristic frequency domains and correlate them to electrochemical processes. However, one drawback of the frequency-domain methods is the need for sophisticated instrumentation. On the contrary, the time-domain analysis method of this invention offers similar opportunity for finding correlations without the complications of the frequency-domain analysis method. Nevertheless, the frequency-domain ranges can be converted to time-domain ranges (and vice versa) of the same measurement. For example, the 1 kHz, 10 Hz, 1 Hz, 0.1 Hz, 1 mHz frequencies correspond to the time-domains of 1 ms, 0.1 s, 1 s, 10 s, and 1000 s, respectively.

Use of the TDPPS

The TDPPS and TD-PDPPS are used in two basic ways such as (a) a stand-alone evaluation of a cell's performance under certain conditions and (b) comparison to data-sets of the pertinent Master Data Tabulation, MDT 77. The latter case is for comparative evaluation of power capability, age, and health of the cell under test. The TDPPS line is compared to the lines of the pertinent MDT. Data are compared column by column. Each parameter (in a certain column) is analyzed and evaluated on a percentage bases of the MDT. An average of the column-results provides the estimate of SOC %, SOH %, performance capability etc.

Master Data Tabulation, MDT, 77

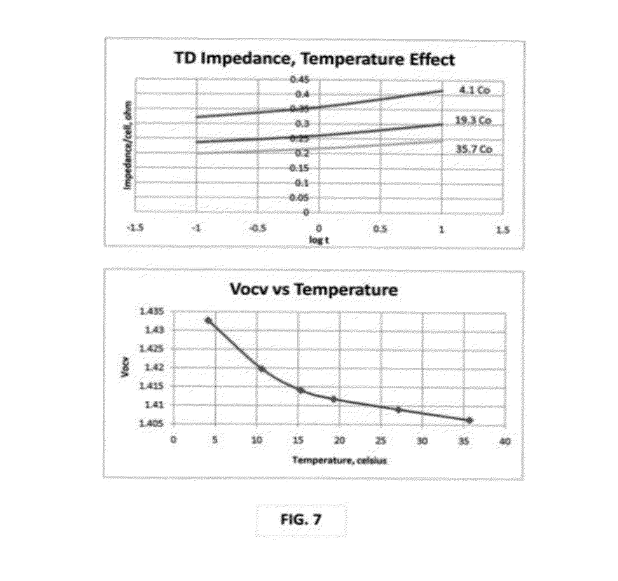

An MDT 77 is a comprehensive mapping (in table format) of several inter-relating TDPPS records. These records are measured systematically over a full discharge half-cycle of a new, full charged cell of perfect condition, designated as 100% SOC and 100% SOH. Then, each TDPPS record is identified with the corresponding SOC % or SOD % and other identifiers. The MDT is stored in memory 30 of apparatus 1. MDT is prepared along a specified standard discharge schedule. Discharge is suspended, at list, 10 times during the process to perform a spot test and collect data for a TDPPS data line to be included in the MDT. Each MDT is unique, valid only for identical cells as defined by chemistry, type, size, etc. An MDT is shown as an example in Table 2. Since TDPPS is function temperature, for complete mapping MDT-s are prepared for, at least, three different temperatures to be able to interpolate for an intermediate temperature. FIG. 7 shows that the temperature effect is significant on the performance parameters. But, the shape of the plot also shows that interpolation is permissible in a certain temperature range depending on the cell chemistry and model. For FIG. 7, in the +/−3 centigrade range. In final format, the MDT-s are stored normalized to 20 centigrade along with the temperature correcting factors. The temperature correcting factors used to normalize the TDPPS (measured at any temperature). Correct evaluation requires that only normalized TDPPS and normalized MDT values are compared.

MDT-s are prepared in two ways, in standard form and application-specific form. The standard MDT is prepared by measuring TDPPS at the standard 1 C-rate along a standard 1 C-rate constant-current discharge half-cycle. On the other hand, the application-specific MDT is prepared by measuring TDPPS at an application-specific form along a constant-current discharge half-cycle. Measurement of the application-specific TDPPS mimics the duty-cycle of a typical application by C-rate and stress-section length. For example, a Ni—Cd battery used in a cordless power drill is evaluated by the TDPPS that measured by mimicking the actual duty-cycle of drilling or screw driving. This process is described in Example 7. Use of the application-specific TDPPS results in better battery state evaluation and diagnosis.

Family of MTD-s 79

Each MDT is strictly valid for the cell type that was used for its generation. An MDT references the conditions for which it is valid. For this, MDT has its own identifiers such as Cell description (chemistry, size, model, type, manufacturer etc.), cycle number, temperature, C-rate of discharge, C-rate of the systematic ST measurements. MTD-s that vary only by the last four parameters are closely related and called a family of MTD-s. The family of MDT-s provides means for interpolation to refine an evaluation for a TDPPS. Family of MTD-s may be called a map.

Atlas of MTD-s 80

A collection of various MTD-s of different cells may be called an atlas of MTD-s.

Use of Test Results

Important feature of the invented method is the simultaneous generation of a wide range of measured and calculated parameters. As above shown, 41 parameters are included in the example TDPPS. Evaluations of the numerous parameters alone or certain combinations provide opportunity for determining cell states and estimate performance capability for various applications even without the need of actual measurements under those applications. Analysis of the numerous parameters included in the TDPPS provides means for diagnosing problems of a cell.

Estimate of Cell's State Indicators

The TDPPS can be used to quantitate cell's state indicators such as performance-capability, age, and state of health (SOH) by comparing it to the pertinent MDT.

Performance Capability

The performance-capability is a comprehensive term, which includes cell's state indicators such as time-domain power: Wt/cell and time-domain impedance, IMPt/cell. Both are used to calculate cell's power for a variety of conditions. The time-domain W and IMP parameters of the TDPPS provide ample possibilities to calculate power and impedance for a wide range of situations of cell's use. The flexibility of TDPPS-based evaluations is an important feature. The present ever-increasing battery-application scenarios actually create a situation that manufacturers cannot keep up to provide specifications available for each option. This fact is especially true for new types of batteries and applications appearing on the market. Thus, users and developers have to depend on their own measurement and judgment, for which an instrument such as apparatus 1 and the invented method is useful.

Performance-Capability Diagram, PCD 81

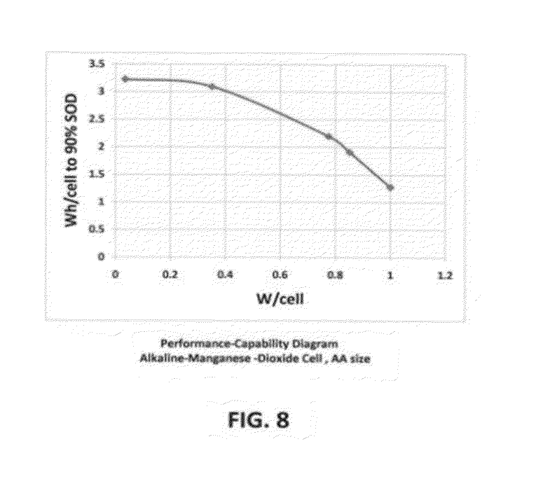

A Performance-Capability Diagram, PCD shows a specified cell's performance on a Wh/cell vs W/cell diagram plane. PCD is similar to a Ragone-type diagram (RTD), which shows performance data point based on a full, constant-power discharge. But, unlike RTD, a PCD shows specified data points that are calculated or estimated from TDPPS. FIG. 8 shows a PCD for an AA-size Alkaline-Manganese-Dioxide cell.

The wide variety of parameters included in TDPPS, TD-PDPPS, and MTD provide means to estimate performance-capability for those conditions which are actually not included in the data-sets. An example illustrates this. A performance-capability diagram (PCD) can be created, which serve basis for comparing different cells from the point of view of power and energy relationship. This diagram is similar to a Ragone-type diagram. But, while a Ragone-type diagram uses Wh values (on the y-axis) that are measured with constant-power discharge to 100% SOD, the proposed PCD relieves this constraint, i.e., the full discharge with constant power. A PCD is shown for the exemplary Cell-12 in FIG. 8. The cell's energy (Wh/cell) obtained in an application duty-cycle refers to a power value (W/cell) that is calculated from TDPPS, especially TD-PDPPS, and MTD data and may be parameterized for any SOD %. The curve in FIG. 8 shows values calculated for 90% SOD.

Cell's Age and Health

While the power capability can be expressed by well defined absolute numbers (W/cell or IMP/cell), the age and SOH are relative indicators. Definition of the cell's age is not straightforward, however. Nevertheless, one way to define cell's age is the SOD % or cycle number. Now-days, however, batteries are used increasingly under non-standard conditions when the cycle number or even SOD % cannot be surely stated. Such situation exists in laptop computers, cell phones, digital cameras, hybrid-car batteries, etc, where the alternating discharge and charge hardly ever goes through full cycles. In these cases, use-history data such as summation of coulomb (Ah) counting for discharge and charge sections are used to estimate the available charge (SOD, SOC) for continued application. If use-history data are not available the judgment is more difficult. The present invention suggests the use of MDT for correlating Vocv and SOD corroborated by impedance evaluation as explained in Exemplary 1. Another definition of the cell's age is the service time on the calendar bases. Example 7 describes these concepts.

To determine SOH, the MDT may be used by comparing the standard TDPPS (of the MDT) to the measured TDPPS. The obtained correlation factor (as %) is the health indicator. Furthermore, determining correlation factors for each parameters of TDPPS is a very effective versatile diagnostic tool for identifying the under-laying problems of the defective cell. With this respect, the time-domain impedance (IMPs,t) analysis is especially effective.

Quasi-Equilibrium as a Qualitative Indication of SOH.

Quasi-equilibrium refers to an observation that the dVs,t and dVr,t polarization values follow a closely equal course in a healthy cell. The dVr,t values are about 20-30 mV less than the dVs,t values. This difference is normal, because the driving force to change the voltage is stronger in a stress section than in a relaxation section. The mV difference at s=10 s is the most pronounced and, thus an indication of the SOH. The abrupt increase at Vocv=0.844 V (Table 2) clearly shows a bad SOH.

### EXEMPLARY EMBODIMENTS

### Example 1

Example 1 describes a complete ST-type testing of a commercial, AA-size alkaline manganese-dioxide cell. FIG. 2 shows the test arrangement. A new cell of 100% SOH (per definition) is used to generate the MDT document to be stored in specified format 77 in memory 30.

Components used in this measurement were an Agilent 34970A as A/D converter-multiplexer 22, an Agilent 82357B GPIB-to-USB as interface 28, and a Toshiba Portege laptop for components 29, 30, and 32. Benchlink program (of Agilent) was used for data-acquisition and Microsoft Excel for data analysis. Switch 5 and selector switch 37 were operated manually.

Cell 12 was subjected to a slow (about 0.1 C) continuous discharge using a 3-ohm resistor 39 connected at position 43. Comparator resistor 4 was 1.00 ohm. A/D sampling time was set to 10 s. In about 1-hour intervals, the discharge was suspended for executing an STs-type spot test.

Parameters of the STs were: selector switch 37 at 41 to 45 connection, load resistance 1.2 ohm (1.00+0.2 from cables 8, 9, and 10), sampling time 0.025 s, stress section 10 s, relaxation section 10 s. The cell's temperature was kept at 22+/−0.5 Celsius all along the whole measurement. Each STs execution generated a TDPPS 75 record line in MDT 77. Each TDPPS line was associated with a SOD % state. The SOD % state was calculated from the sum of the 10-s long Ah/cell increments between STs points. The SOD % relates to a nominal 2.7 Ah full discharge. The MDT for Example 1 is shown in Table 2.

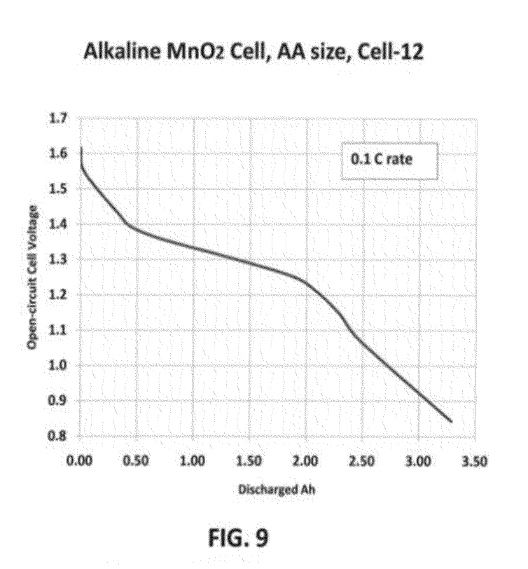

The measured test parameters can be charted in various combinations to provide a wide array of performance analysis. For example, the MDT can be used to document the cell's electrochemistry. FIG. 9 shows a Vocv vs. discharged-Ah chart. This chart is a typical representation of the electrochemical reactions within the cell. Brake points on the curve indicate phase changes of the active materials at the Ah/cell (SOD %) values. The phase-changes occur at 15.5, 72.5, and 87.5 SOD %. FIG. 9 was measured for an Alkaline-Manganese-Dioxide cell.

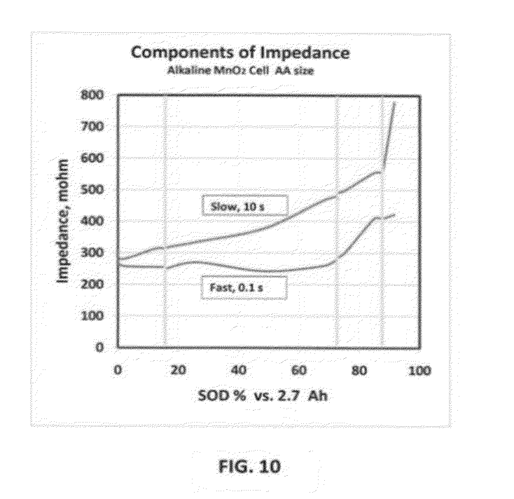

Marking the phase-change information in various charts is very useful. Based on FIG. 9, FIG. 10 illustrates the cell's impedance as function of SOD % and how it relates to phase changes. The fast and slow components are plotted separately. Magnitude of the impedance correlates to the phase changes. Ratio of the fast and slow component carries information of cell's age, even when the use-history is not known. Because of the high impedance, the cell becomes useless at 87.5 SOD % owing to a phase change.

### Example 2

Example 2 applies to a setup used to measure TDPPS on multiplicity of cells, which are connected together serially in a battery. The measurement can be executed by several modes using the STs or STpd method. These modes are: (a) The ST is executed on each cell individually. Voltage leads 7 and 7′ are connected to only one of the cells at a time and moved manually over to the next one-by-one. (b) The total battery voltage measured by voltage lead pair 7 and 7′. This is an option when the terminals of the individual cells of the battery are not accessible. (c) A more complicated method is to connect each cell individually to a multi-channel A/D converter 22. Each cell connection at the converter must be electrically isolated from each other. This method ensures absolutely synchronous measurement of each cell, but slows down the data acquisition because so many cells have to be scanned through. In all cases, one comparator resistor 4 is enough. Each cell is associated with its own TDPPS record.

In Example 2, case b, a compensator voltage set 63 was used as shown in FIG. 1A at numeral 63. So, a reduced voltage signal was sent to connections 23 and 24 to avoid overloading the A/D converter 22 Channel 1.

In general terms, compensator voltage source 63 is connected between 17 and 23 points with counter polarity to cell 12 (i.e., the positive of 63 is connected to the positive terminal of cell 12 at 17). Purpose of this arrangement is to reduce the actual input voltage to Channel 1 and, thus, improve precision of the voltage measurement. For example, a 9-V cell can be used as compensator voltage source 63 when a 12-V battery is tested. A convenient compensator voltage set is built from serially connected two 9-V cells and six 1.5-V AAA size commercial cells. If the cells of the compensator voltage source are kept open circuit all time, their voltage remain constant or drift so slowly that can be considered constant during the TDPPS measurement. This set up is good to set any compensator voltage between 1.5 to 27 V in 1.5-V increments. The channels of converter 22 have 10 Mohm input resistance. Consequently, the current load on set 63 is negligible and the voltage stays very stable within 0.1 mV. The exact value of the selected set-voltage of source 63 must be precisely measured before the ST test. The exact value is recorded among the identifiers and used as off-set voltage in Channel 1.

### Example 3

An STd-c 68 test is described. The purpose of this test was to determine the charge up-take, charge-rate capability of a used Nickel-Metal-Hydride AA-size cell. The test was carried out in an apparatus shown in FIG. 3, Embodiment 3.

The measuring circuit included a discharge-charge selector switch 47. Switch 47 was alternatively set to discharge or charge by manual control 52 for a program of 10-10 seconds, shown in FIG. 11. The charger cell was a 25-Ah capacity, 2-V lead-acid cell. The high capacity of the charger cell and, consequently, its relatively low (negligible) power-domain impedance (vs the test cell) ensured that the measurement was valid for cell 12. The positive terminal of cell 12 and that of the charger cell were connected together. The C-rate of charge and discharge was set to 0.20 and 0.45, respectively, using resistors 39 and 40.

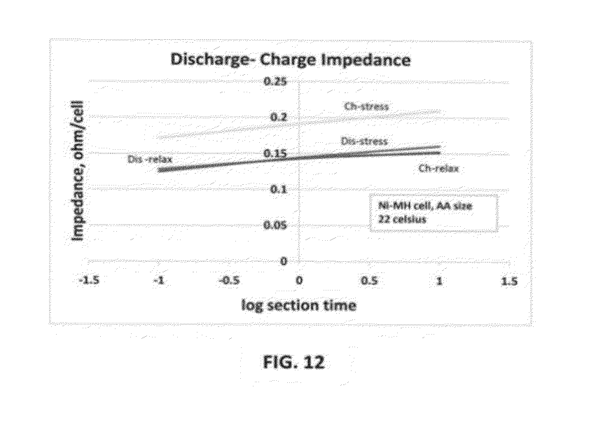

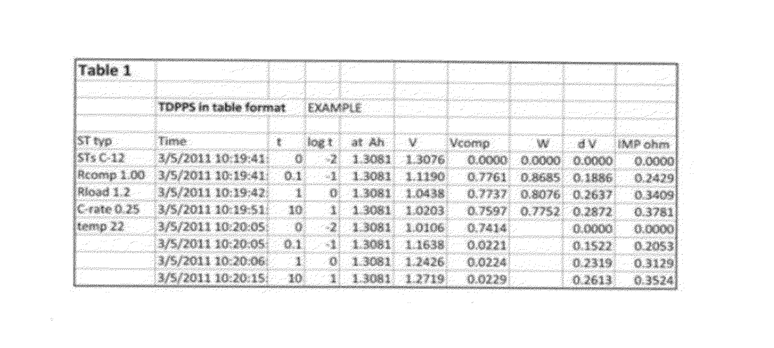

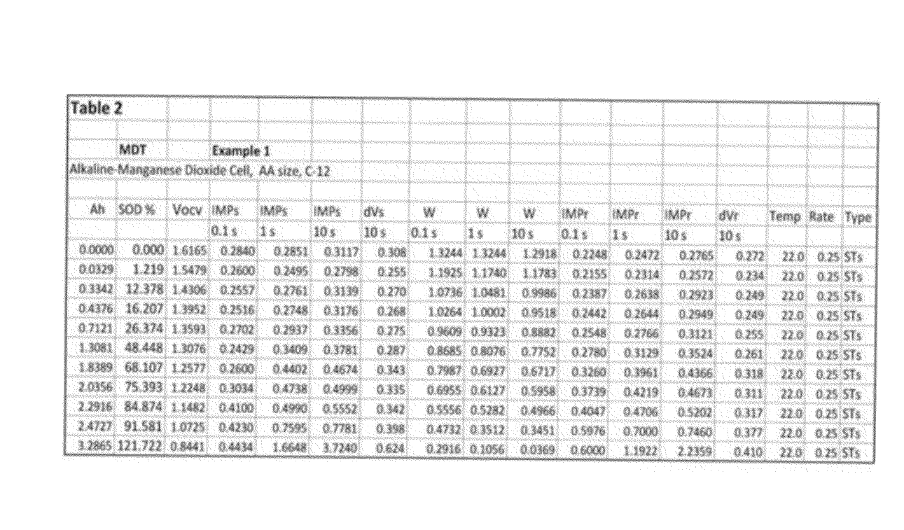

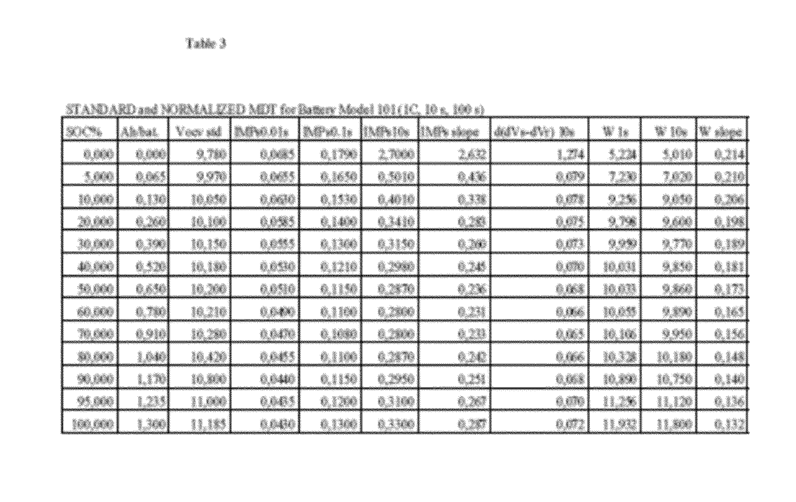

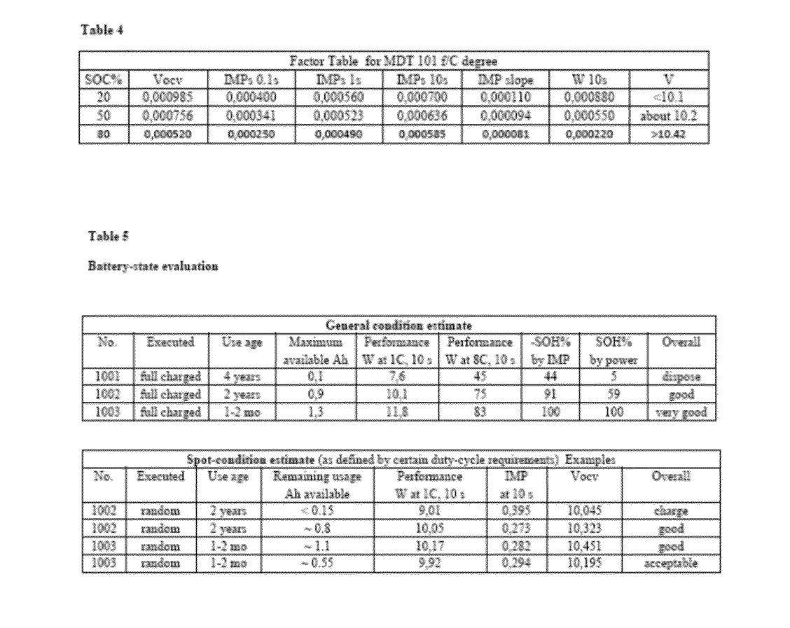

The impedance chart in FIG. 12 indicates that the charge-rate capability of this cell is rather poor. Even at 0.2 C-charge-rate, the charge-stress section impedance became too high.

### Example 4

In this example, cell 12 is in its use-circuitry (e.g., in a car, power tool, etc.). FIG. 4 shows this arrangement. Cell 12 is in a service equipment 53, in which the service load 54 determines the load and load pattern. Three important differences distinguish this arrangement from the ones that are shown in FIGS. 1 and 2. (a) The measurement is energized by the use-circuit. (b) Instead of the regular comparator resistor 4, which is a component of apparatus 1, an appropriate section of the current-carrying cable 57 is used as comparator resistor. (c) Switch 5 may be omitted, if the service equipment's own switch 55 can be operated for the ST measurement.

### Example 5

Example 5 is a car battery test. FIG. 4 shows the measuring circuit. The STs is executed by switching on and off the normal car components such as lights, defroster, etc. These components are being a part of the circuit serve as load resistor 54. The comparator resistor is an appropriate section 57 of the current—carrying cables. Section 57 can be conveniently the fuse in the appropriate circuit or even better if the fuse is temporarily replaced by Rcomp. The car engine must be at standstill during the measurement.

### Example 6

Example 6 is a special case for FIG. 4, in which a battery/cell remains under its normal working or testing condition. This method is applicable if the testing pattern includes a fast changing load section, for example, during an SFUDS test used for standard testing of electric-car batteries. The SFUDS schedule includes zero current and load current sections. Any of the sharp load steps of the SFUDS can be used for an on-the-flay spot test, STotf 69. The sharp load step generates a stress section. Depending on the actual conditions either resistor 4 or cable section 57 is used for comparator. The software of apparatus 1 monitors the test cell's voltage signal 7 and 7′, and the voltage change of comparator resistor 4 or 57. A rapid change of the voltage signal in Channel 2 triggers the measurement of STotf.

### Example 7

### Evaluation of Batteries Used in a Ryobi Cordless Drill (HP-962)

Three originally identical batteries sold for this particular hand tool were tested. Description: 9.6 V, 1.3 Ah (No. 1311146), consists of 8 pcs sub-C cells. Model designation in TDPPS identifiers is 101.

1/ Battery 1001, bought in 2008 as part of the drill kit;

2/ Battery 1002, bought new in 2010 and used alternatively together with Battery 1001.

3/ Battery 1003, bought new in 2012 for the specific purpose to create the MDT-101.

Preparation of MDT-101.

Step 1. Charge of Battery 1003 to 100% SOC. The original charger, part of the tool kit, bought in 2008 was used.

Step 2. Constant-current (300 mA) discharge of Battery 1003. Circuit shown in FIG. 2 was used. A KEPCO BOP bipolar, four-quadrant power supply was connected to 20 and 15. The battery holder, 62, was a special thermostat kept at 20 centigrade. The current was suspended at every 20-min interval. Each discharge section produced an exactly known amount of discharged Ah. At the end of the complete discharge, the SOC % values of each section were calculated.

Step 3. Preparation of the Raw MDT 101. During every open-circuit period, a Spot Test was executed at about 1 C-rate using 10 ohm (RA 39, FIG. 2) load (10-s stress and 100-s relax periods). 1 C-rate was chosen because this matched the duty-cycle-current of drilling.

Step 4. Preparation of the Standard (1 C-rate), Normalized (20 centigrade) MDT 101 (S-N MDT 101). In this final format, the TDPPS values were recalculated for 10% SOC increments. Table 3 shows a simplified form of S-N MDT 101. In this form, the most important columns are shown only, those are the ones used in evaluation.

Step 5. Temperature-function of the TDPPS values. At three, exactly known SOC % state, Battery 1003 was subjected to a thermal cycle between 0 and 45 centigrade and TDPPS was measured at approximately 3-degree intervals. The obtained factors are summarized in Table 4. Use of Table 4 is necessary to normalize the subsequently measured TDPPS values. Only normalized TDPPS values and S-N MDT 101 can be compared to calculate battery states.

Measurement of Battery States.

The battery state measurement (battery state estimate) involves the following steps:

Step 1. Measurement, recording of a raw TDPPS according to a predetermined schedule including intensity and length of the stress section, and length of the relax section of the required spot test; for example, in Example 7, the TDPPS schedule is nominal 1 C, 10 s, 100 s. Also, the battery temperature is measured and recorded as part of the TDPPS.

Step 2. Conversion of the raw TDPPS to S-N TDPPS.

Step 3. The S-N TDPPS is compared to the S-N MDT 101 matrix to find correlation for each column. Then, the individual column estimates are summarized in a concluding statement.

Step 4. The evaluations are carried out by two different methods and summarized in Table 5.

First, the General-condition estimate method evaluates the SOH % of the battery based on full charged condition. Depending on preference, either the power capability degradation or the impedance increase is used as bases of evaluation. The power capability estimate is more of an indication of the actual applicability condition. On the other hand, the impedance increase is an indication of the battery's progressive degradation. The calculated SOH % value defines the battery's health independent of any use situation. The General-condition estimate procedure should be repeated and recorded regularily, quarterly or half-yearly to keep track the change of the battery.

Second, the Spot-condition estimate method evaluates the battery as is at a particular time of a use mission. This method is useful to estimate the remaining mission time according to a certain mission schedule before a charge is needed.

The overall statement is based on the General-condition and the Spot condition, which numerically define the battery's state. The overall statement is a simple practical summary and direction for use.

1. A method for generating data to evaluate quality of a galvanic cell to be tested,
wherein parameters of a good quality reference cell of the same type are generated by performing the following operations:
a) measuring temperature of said cell versus time;
b) measuring voltage of said cell in load-free condition;
c) applying a predetermined load current across a comparator resistor to the cell for a first predetermined period
d) measuring voltage of said cell versus time during said first predetermined period;
e) measuring voltage drop on said comparator resistor caused by load current flowing from said cell d versus time during said first predetermined period;
f) switching off said load after the expiry of said first predetermined period;
g) measuring voltage of the cell versus time for a second predetermined period after switching off said load
h) normalizing data obtained by said steps a) to g) to a predetermined temperature
i) setting up a look-up table MDT including said normalized data identifying the type of the said cell and measured data;
j) generating parameters of the cell to be tested by performing the same operations as defined in steps a) to h);
k) conveying data gained as defined in j) for comparing them to the data of said look-up table MDT.

2. The method as claimed in claim 1, wherein said look-up table MDT includes data gained along a logarithmic time-scale.

3. The method as claimed in claim 1, wherein steps a) to g) are carried out is a stabilized state of the cell.

4. The method as claimed in claim 1, wherein
c1) applying a predetermined charge current to said cell for a third predetermined period;
d1) measuring voltage of said cell versus time during said third predetermined period;
e1) measuring voltage drop on said comparator resistor caused by load current flowing from said cell versus time during said third predetermined period;
f1) switching off said load after the expiry of said third predetermined period;
g1) measuring voltage of the cell versus time for a fourth predetermined period after switching off said load
l) h1) normalizing data obtained by said steps a1) to g1) to a predetermined temperature
i1) completing said look-up table MDT by data gained as defined in c1) to h1);
j1) generating parameters of the cell to be tested by performing the same operations as defined in c1) to h1);
k1) conveying data gained as defined in j1) for comparing them to the data of said look-up table MDT.

5. The method as claimed in claim', wherein said load defined in c) comprises at least two different loads.

6. The method claimed in claim', wherein said measurements effected during said predetermined periods are performed at sampling intervals not longer than 50 ms, preferably 25 ms, particularly not longer than 10 ms at the beginning of said predetermined periods.

7. The method as claimed in claim 6, wherein said sampling is effected according to a logarithmic time scale.

8. Apparatus for carrying out the method according to claim 1 and for generating data to evaluate quality of a galvanic/cell to be tested, said apparatus including means for
a) measuring temperature of a cell versus time
b) measuring voltage of said cell;
c) applying a predetermined load current across a comparator resistor to the cell for a first predetermined period at a first time instant, said means including a switch;
d) measuring voltage of said cell versus time during said first predetermined period;
e) measuring voltage drop on said comparator resistor caused by load current flowing from said cell versus time during said first predetermined period
f) switching off said load after the expiry of said first predetermined period;
g) measuring voltage of the cell versus time for a second predetermined period after switching off said load;
h) conveying data gained as defined in h) for evaluation;
i) computing means adapted for normalizing said conveyed data to a predetermined temperature and for selecting values along a logarithmic time scale;
j) data storage for setting up a look-up table including data of a parameters of a good quality reference cell identifying the type of the said cell and measured data;
wherein said computing means is adapted to compare measured and normalized data of the cell to be tested with that of said reference cell previously stored in said look-up table

9. The apparatus as claimed in claim 8, further including means for
c1) applying a predetermined charge current across a comparator resistor to said cell for a third predetermined period;
d1) measuring voltage of said cell versus time during said third predetermined period;
e1) measuring voltage drop on said comparator resistor caused by load current flowing from said cell d versus time during said third predetermined period;
f1) switching off said load after the expiry of said first third predetermined period;
g1) measuring voltage of the cell versus time for a fourth predetermined period after switching off said load

10. The apparatus as claimed in claim 8, wherein said means for applying a predetermined load current across a comparator resistor to the cell for a first predetermined period at a first time instant includes a switch connected to at least one of an interface of a data-acquisition and data processing hardware; and an manual operation from operator.

11. The apparatus as claimed in claim 8, wherein said comparator resistor comprises a section of a cable carrying said load current.
